(19) United States
(12) Patent Application Publication
(10) Pub. No.: US 2025/0020579 A1
(43) Pub. Date: Jan. 16, 2025

(54) HIGH-TEMPERATURE MOLTEN SALTS STRUCTURE ANALYSIS SYSTEM

(71) Applicants: Massachusetts Institute of Technology, Cambridge, MA (US); The Research Foundation for the State University of New York, Albany, NY (US)

(72) Inventors: Boris Khaykovich, Cambridge, NY (US); Guiqiu Zheng, Cambridge, NY (US); David Sprouster, Albany, NY (US)

(21) Appl. No.: 18/708,824

(22) PCT Filed: Nov. 7, 2022
(86) PCT No.: PCT/US2022/079367

§ 371 Date: May 9, 2024

Related U.S. Application Data
(60) Provisional application No. 63/277,997, filed on Nov. 10, 2021.

(51) Int. Cl. G01N 21/31; G01N 1/44

(52) U.S. Cl. CPC G01N 21/31; G01N 1/44

(57) ABSTRACT

A system for determining atomic structure and dynamics of salt under certain temperatures as a function of temperature above and below salt melting, contains a quartz tube containing a first end and a second end, and a graphite rod that is located within the quartz tube. The graphite rod contains a hollow center that extends from a top portion of the rod to a location prior to a bottom of the rod, wherein the bottom portion of the rod is enclosed. A sample of salt is located within the hollow center of the graphite rod. A filling material having the characteristics of not reacting to the graphite rod and not changing state with heating of the salt to a melting point of the salt, and wherein the filling material is positioned beneath the graphite rod between the second end of the quartz tube and the bottom of the graphite rod.

### CROSS-REFERENCE TO RELATED APPLICATIONS

The present application claims to priority to U.S. provisional patent application No. 63/277,997, entitled “Novel Design of High-Temperature Molten Salts Structure Analysis System”, filed on Nov. 10, 2021, which is incorporated herein by reference in its entirety.

### FIELD OF THE INVENTION

The present invention is related to desirable clean energy sources, and particularly, to determining response of salts to high temperatures in potentially hazardous clean energy sources.

### BACKGROUND OF THE INVENTION

Clean energy sources are highly sought after in a time where traditional energy sources that are not clean have been criticized by the public and the media. Among others, one clean energy source is the nuclear power plant. A nuclear power plant is a thermal power station in which the heat source is a nuclear reactor. As is known, nuclear power plants heat water to produce steam. The steam is used to spin large turbines that generate electricity.

A heat source of the nuclear reactor can be nuclear fuel dissolved in molten salt. Molten salt is a salt that is solid at standard temperature and pressure but turns into a liquid when heat is added to it. Molten salts are of interest in heat transfer and heat storage because they have a high heat capacity, high melting point, high boiling point, and low vapor pressure. The molten salts have a large range between their melting and boiling points. This allows the reactors to operate at high temperatures and low pressures, thereby making them more efficient at generating electricity and safer. Molten salts as potential candidates of heat storage media, heat transfer coolants, and fuel solvents in renewable clean energy areas (solar energy and nuclear energy), and blanket in advanced fusion energy systems, have been attracting much attention.

Molten salts can also be used in nuclear reactor designs as the coolant medium. Since salts have low vapor pressures and high boiling points, there is less of a risk of a loss of coolant accident than reactors that use water as a coolant. While there is less of a risk of a loss of coolant, there is still a risk with molten salts and a loss of molten salt coolant can result in major hazardous conditions that could affect the environment and health of those surrounding the region of the coolant loss.

For at least these reasons, it is necessary to determine and predict how the molten salts will behave under certain temperatures and chemical conditions. To determine this behavior, it is desirable to be able to determine the atomic structure and dynamics of the salt under certain temperatures. One means of determining the atomic structure and dynamics of the salt is through use of an X-ray beam. However, it is a high challenge to analyze the structure and thermal behavior of molten salts at high temperatures using advanced X-ray beam techniques due to the intrinsic properties of molten salts such as high reactivity with air (oxygen and moisture), high corrosivity with most materials, and relatively high melting point (400-500° C.).

Therefore, there is a need in the industry to provide a safe, efficient, and reliable way to determine the effects of certain temperatures on molten salt within a potentially hazardous clean energy source.

### SUMMARY OF THE INVENTION

Embodiments of the present invention provide a system for determining atomic and molecular structure of salt as a function of temperature above and below melting. Briefly described in structure, in accordance with a first exemplary embodiment of the invention, the system for determining atomic structure and dynamics of salt under certain temperatures as a function of temperature above and below salt melting, contains a quartz tube containing a first end and a second end. A graphite rod that is provided and located within the quartz tube, wherein the graphite rod contains a hollow center that extends from an open top portion of the rod to a location prior to a bottom of the rod, wherein the bottom portion of the rod is enclosed. A sample of salt is located within the hollow center of the graphite rod. A filling material having the characteristics of not reacting to the graphite rod and not changing state with heating of the salt to a melting point of the salt, and wherein the filling material is positioned beneath the graphite rod between the second end of the quartz tube and the bottom of the graphite rod.

In accordance with an alternative embodiment of the invention, the system contains a quartz tube containing a first end and a second end. A graphite rod is provided and located within the quartz tube, wherein the graphite rod contains a hollow center that extends from an open top portion of the rod to a location prior to a bottom of the rod, wherein the bottom portion of the rod is enclosed. A sample of salt is located within the hollow center of the graphite rod and a filling material is provided, having the characteristics of not reacting to the graphite rod and not changing state with heating of the salt to a melting point of the salt. The filling material is positioned beneath the graphite rod between the second end of the quartz tube and the bottom of the graphite rod. A plug is positioned above the open top portion of the rod, closing the opening of the graphite rod, wherein the plug fits entirely within the quartz tube and wherein the system also contains a quartz wool positioned on top of the plug, wherein the quartz wool also is positioned entirely within the quartz tube.

A second embodiment of the system is like the first, however the graphite rod further contains a through-hole that extends from a first side of the graphite rod to a second side of the graphite rod, wherein the salt can be accessed through the through-hole, however, molten salt cannot pass therethrough due to non-wettability of graphite to molten salt.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principals of the invention.

FIG. 1 is a schematic diagram illustrating the present high-temperature molten salts structure analysis system in accordance with a first exemplary embodiment of the invention.

FIG. 2 is a schematic diagram illustrating the present high-temperature molten salts structure analysis system in accordance with a second exemplary embodiment of the invention having a through-hole extending through a graphite rod located within a quartz tube of the system.

FIG. 3 is a schematic diagram illustrating the present high-temperature molten salts structure analysis system of the first exemplary embodiment of the invention having a cap thereon, which is positioned through use of quartz wool.

FIG. 4 is a schematic diagram illustrating the present high-temperature molten salts structure analysis system in accordance with a second exemplary embodiment of the invention having the through-hole extending through the graphite rod and having a cap thereon, which is positioned through use of quartz wool.

### DETAILED DESCRIPTION

The present system is a high-temperature molten salt structure analysis system. This system allows for examination of the structure of salt located therein, whether the salt is in a solid or molten liquid state. Such salt would typically be in a double-encapsulation environment due to the hygroscopic, corrosive, or radioactive nature of the salt. This examination of the structure of salt results in data that can be continuously collected at various temperatures, so as to determine a response of the salt under specific temperatures, and therefore, be able to simulate a response of the salt when used in a clean energy source.

The present system allows for the validation of computer simulations of molten salt at different temperatures at a nanoscale level, so that a party may predict the response of molten salt in a macroscale application. Macroscopic properties revealed during the simulation include, but are not limited to, the pair-distribution function (a microscopic description of the salt structure), and viscosity, heat capacity, thermal conductivity, and phase diagram, which are macroscopic properties of the solution. As a non-limiting example, these properties can reveal how molten salt will respond in a molten salt reactor, and therefore, how a nuclear reactor would respond.

As will be described in detail herein, the present system provides a novel design for sealing molten salt samples in a quartz tube for analyzing molten salt atomic structure and dynamics at various temperatures using advanced x-ray beam facilities, and optical facilities that provide, for example, visible light, ultraviolet light, or infrared light. Such analysis can be provided on a temporary or continuous basis. The present system fully utilizes the advantages of high temperature materials sealing molten salt samples and combines the easy-accessible facilities of X-ray beam techniques for the continuous collecting of data of the molten salt samples at various temperatures.

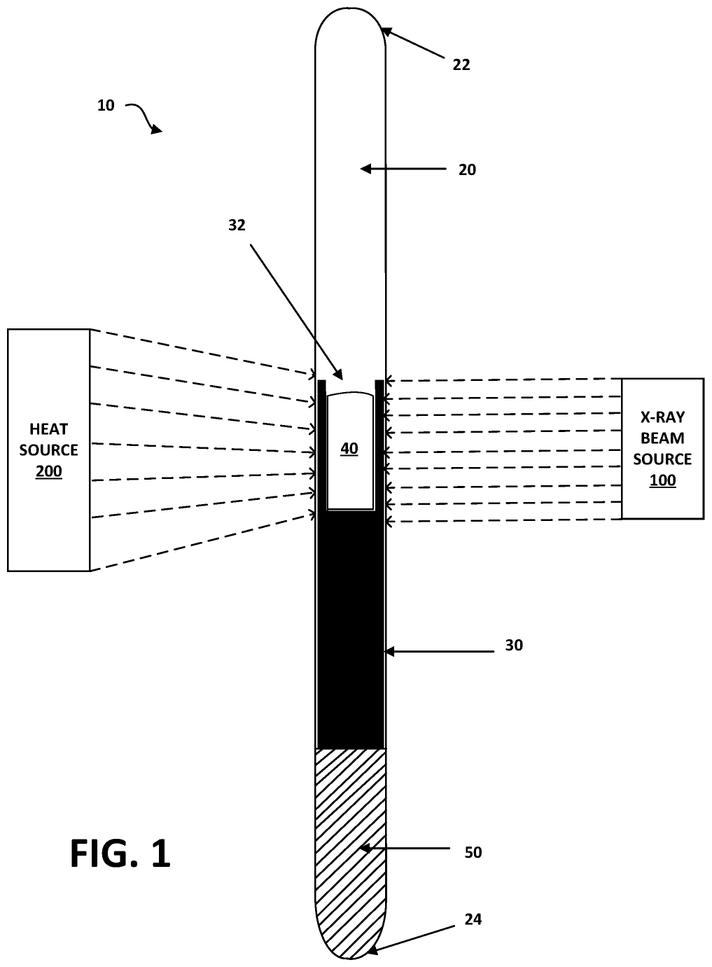

FIG. 1 is a schematic diagram illustrating the present high-temperature molten salts structure analysis system 10 in accordance with a first exemplary embodiment of the invention. For safe structural analysis to be performed, molten salts must be contained, sealed in a container, and sealed in a material that is compatible with the salt chemically so as not to react when the salt melts. The material also must be compatible with an X-ray beam, meaning that the X-ray beam should be able to penetrate the transparent material, without attenuation, thereby allowing for the analysis.

As shown by FIG. 1, the structure analysis system 10 contains a quartz tube 20. The quartz tube could be, for example, but is not limited to, a nuclear magnetic resonance (NMR) tube, which is a thin walled quartz capillary/tube used to contain samples in nuclear magnetic resonance spectroscopy.

The quartz tube 20 contains a first end 22 and a second end 24, wherein for description purposes, the first end 22 is described as being at a top portion of the quartz tube 20 and the second end 24 is described as being at a bottom portion of the quartz tube 20. It is noted, however, that the terms “top” and “bottom” are relative and comparative to each other. As a result, these terms really are simply used with regard to describing the figures described herein.

Preferably, the quartz tube has a small outer diameter, for example, but not limited to, 2-5 mm, and small wall thicknesses. The thickness must be small enough for an x-ray beam to penetrate. As is described in detail herein, it is the intent of the quartz tube 20 to provide an enclosure for molten salt at high temperature after sealing the quartz tube 20 under vacuum (or filling it with inert gas). Such sealing could be done with a micro-torch. Beneficial characteristics of using a quartz tube include the quartz tube allowing for quick heat transfer through the quartz tube to molten salt therein, as described herein, owing to the high thermal conductivity of quartz.

The stability of quartz at high temperature enhances the safety of melting salt in it. Quartz tubes are normally utilized as sample holders for x-ray methods because of their transparency to X-rays and low background. Quartz is also easy to seal, but it interacts with fluoride molten salts since it chemically is not inert at high temperature. Therefore, a liner is needed between the salt and the quartz tube 20, that is compatible with the salt, the quartz, and x-rays, as well as being easily machinable.

It should be noted that while the present description provides for an embodiment where the elongated tube is made of quartz, the desirable and necessary characteristics of the tube include that the material of the tube does not become soft with temperatures of interest, such as, but not limited to, temperatures used to liquefy the salt, and that the material does not release a contaminant when heated to a certain level. The material of the tube also cannot block X-rays. The tube may be made of a material that is not quartz, which has each of these desirable and necessary characteristics.

As shown by FIG. 1, the present high-temperature molten salts structure analysis system 10 contains an elongated graphite rod 30 that is located within the quartz tube 20. The graphite rod 30 serves as the necessary liner. The graphite rod 30 contains a hollow portion 32 that extends from a top portion of the graphite rod 30, down a distance that allows salt 40 to be placed within the hollow portion 32. As a non-limiting example, a several-mm deep hollow portion 32 may be provided on the top portion of the graphite rod 30. Since the hollow portion 32 provides a space for holding molten salt samples, the rod 30 must be made of a material that does not interact with quartz at high temperatures. Graphite is compatible with the salt, the quartz, and x-rays, as well as being easily machinable. It is noted, however, that another material containing these properties may instead me used. The graphite rod 30 is sealed inside the quartz tube 20.

Different types of salt may be used in accordance with the present system. One example of such a salt may be a fluoride salt, although the present invention is not limited to use of a fluoride salt. Of course, in accordance with the present system, the selected salt should become molten at higher temperatures.

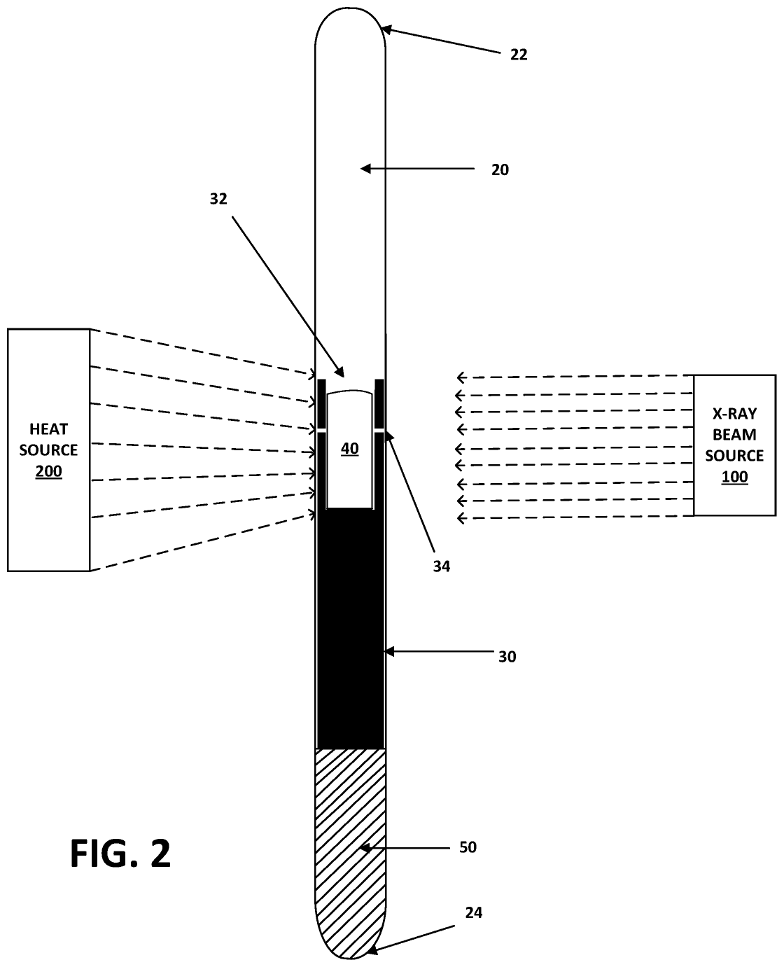

In accordance with a second exemplary embodiment of the invention, as shown by the schematic diagram of FIG. 2, which is a cross-sectional diagram, the elongated graphite rod 30 contains two small holes, also referred to herein as through-holes 32. The through-holes 32 extend from a first side of the graphite rod 30 to a second side of the graphite rod 30, through the hollow portion of the graphite rod 30. The through-holes 32 provide a path for a relatively low energy x-ray beam or visible light to pass through molten salt, without attenuation by the graphite rod 30. It is noted that graphite is non-wettable material to molten salt, so molten salt does not leak out through the small holes when the top surface of molten salt is higher than the through-holes 32. This use of the through-holes 32 allows for obtaining additional information about the chemical and structural state of the salt and impurities, as is explained in further detailed hereinbelow.

As shown by both FIGS. 1 and 2, an x-ray beam source 100 is provided for transmitting x-ray beams toward the quartz tube 20. Specifically, the x-ray beams are focused toward the salt 40 within the hollow portion 32 of the graphite rod 30. X-ray beams are used to allow for examination of the atomic structure and dynamics of the salt under certain temperatures. It is noted, however, that a different source of optical access may be used.

In the embodiment of the invention containing through-holes 34, a different optical source of light may be used, such as, but not limited to, a laser. This is the case because the through-holes 34 provide optical access to the salt 40, which allows for the obtaining of the additional information about the chemical and structural state of the salt and impurities.

A heat source 200 is provided for heating the salt 40 within the hollow portion 32 of the graphite rod 30, all of which are within the quartz tube 20. The external heat source 200 can quickly transfer through the quartz tube 20 to the molten salt 40 owing to the high thermal conductivity of quartz.

The heat source 200 may be one of many different types of heat sources that are capable of providing heating temperatures high enough to melt the salt 40 and bring the molten salt to a state desired for analysis. An example of a heat source 200 may be, for example, a furnace. In addition, this design does not require a high-temperature furnace to melt the salt sample. A heat gun that is typically equipped with advanced x-ray beam facilities is a convenient approach to heat the salt 40 to molten state where an x-ray beam passes through.

Range of temperature provided by the heat source 200 may vary, however it is noted that a range of room temperature to approximately 1100 degrees Celsius is likely sufficient, although a higher and lower range may be used, as long as the quartz tube 20 does not begin to soften.

In order to keep the graphite rod 30 within a specific location of the quartz tube 20, a filler 50 is provided within the quartz tube 20. The filler 50 is used in accordance with the first exemplary embodiment of the invention (FIG. 1) and the alternative embodiment of the invention (FIG. 2). The filler 50 is positioned beneath the graphite rod 30, between the graphite rod 30 and the second end 24 of the quartz tube 20. The amount and density of the filler 50 has a direct effect on whether the graphite rod 30 is maintained in position.

One example of filler material that may be used might be, but is not limited to, a quartz wool. The quartz wool may be positioned on the bottom of the quartz tube 20 providing a separation for preventing the graphite rod 30 from hitting the quartz tube 20 bottom. The quartz wool also provides a space for thermal expansion of the graphite rod 30 that is likely to break the quartz tube 20.

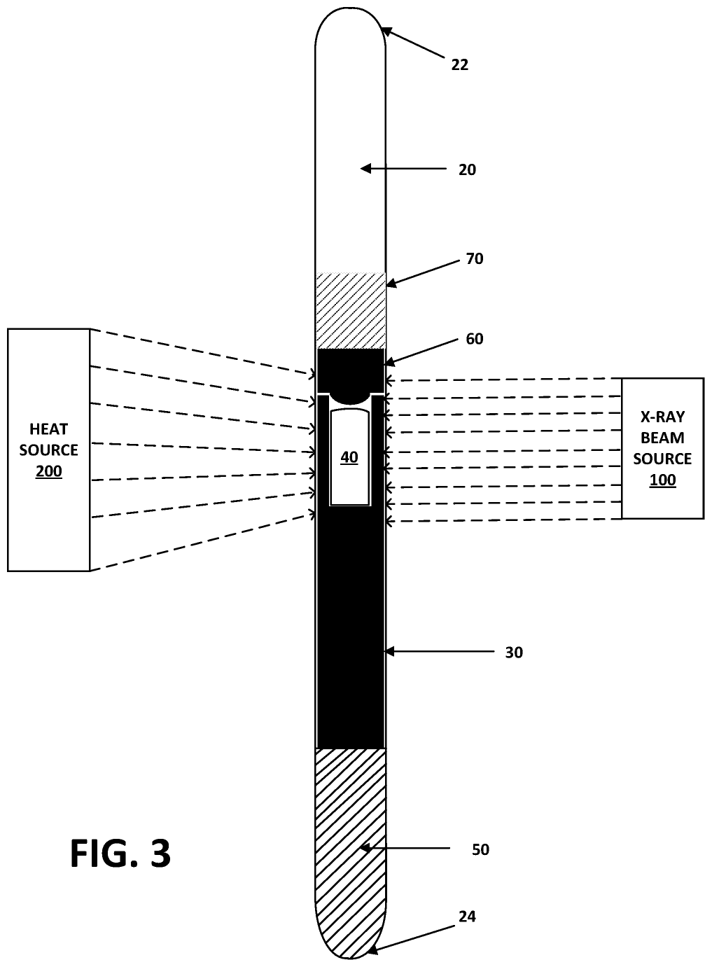

Referring to FIG. 3, the present high-temperature molten salts structure analysis system 10 of the first exemplary embodiment of the invention, may contain a cap 60 for sealing the salt 40 within the hollow portion 32 of the graphite rod 30. Preferably, since the graphite rod 30 is made of graphite, the cap 60 is also made of graphite. Of course, a different material could be used for the cap, however, it would need to have the desirable properties of graphite as previously mentioned.

The cap 60 is positioned above the opening of the graphite rod 30 in order to seal the salt within the hollow portion 32. A nub may be located on the portion of the cap 60 that is extending downward toward the graphite rod 30. If the cap 60 contains a nub, the nub extends into the hollow portion 32 enough to maintain the salt within the hollow portion, and to make sealing the cap 60 to the graphite rod 30 easier.

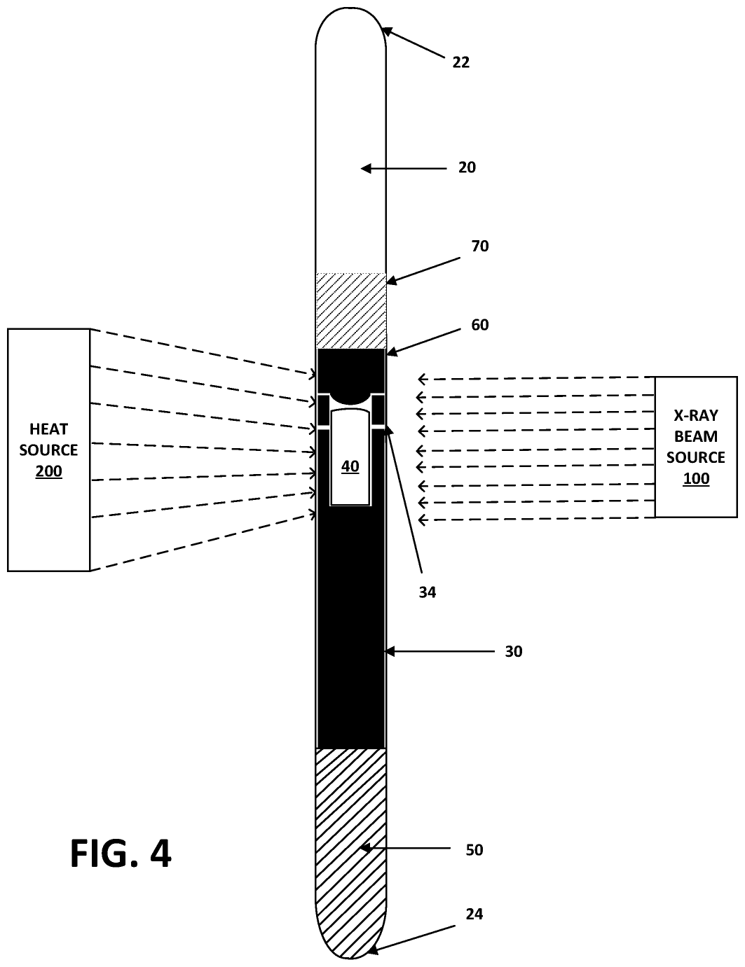

FIG. 4 is a schematic diagram illustrating the present high-temperature molten salts structure analysis system of the second exemplary embodiment of the invention having the through-hole extending through the graphite rod and having a cap 60 thereon, which is positioned through use of a second filler 70. Similar to the first filler 50, the second filler 70 may be quartz wool.

There are many applications of the present system including, but not limited to, the high-temperature X-ray and neutron diffraction measurements, X-ray spectroelectrochemistry, optical spectroscopy, for in-situ analyzing the molten salts structure and physiochemical properties at extreme environments to develop the applications of molten salt in solar energy, nuclear energy, and heat transfer and storage of other types of emerging renewable energies. Application of the present system could be to critical laboratory supplies for the national laboratories having the advanced analysis facilities of X-ray beamlines at synchrotrons, neutron source. It also could be used for necessary consumable sample preparation kits for research, quality assurance, and inspection of molten salt-related industries.

We claim:

1. A system for determining atomic and molecular structure of salt as a function of temperature above and below melting, comprising:
a quartz tube containing a first end and a second end;
a graphite rod located within the quartz tube, wherein the graphite rod contains a hollow center that extends from an open top portion of the rod to a location prior to a bottom of the rod, wherein the bottom portion of the rod is enclosed;
a sample of salt located within the hollow center of the graphite rod; and
a spacer that is stable at high temperature and does not react to the graphite rod, wherein the spacer positions the graphite rod at a desired position within the quartz tube,
wherein the quartz tube is sealed with the graphite rod, salt, and spacer therein.

2. The system of claim 1, wherein the spacer is filling material that is not reactive to the quartz tube or to the graphite rod, and which does not melt with increased temperature that causes the salt to become molten salt, and wherein the filling material is positioned beneath the graphite rod between the second end of the quartz tube and the bottom of the graphite rod.

3. The system of claim 2, wherein the filling material is quartz wool.

4. The system of claim 1, wherein the graphite rod further contains a through-hole that extends from a first side of the graphite rod to a second side of the graphite rod, wherein the salt can be accessed through the through-hole.

5. The system of claim 4, wherein the salt within the graphite rod cannot pass through the through-hole with the salt is in its molten state.

6. The system of claim 1, further comprising a heat source for heating the salt from a solid state to a molten state.

7. The system of claim 1, further comprising an optical spectroscopy device for providing optical spectroscopy of solid and molten salt.

8. The system of claim 1, further comprising a plug positioned above the open top portion of the rod, closing the opening of the graphite rod, wherein the plug fits within the quartz tube.

9. The system of claim 8, wherein the plug fits entirely within the quartz tube and wherein the system also contains a quartz wool positioned on top of the plug, and wherein the quartz wool also is positioned entirely within the quartz tube.

10. The system of claim 8, wherein the plug is a graphite plug.

11. The system of claim 8, further comprising a second spacer located between the first end of the quartz tube and the plug.

12. A system for determining atomic and molecular structure of salt as a function of temperature above and below melting, comprising:
a tube containing a first end and a second end;
a graphite rod located within the quartz tube, wherein the graphite rod contains a hollow center that extends from an open top portion of the rod to a location prior to a bottom of the rod, wherein the bottom portion of the rod is enclosed;
a sample of salt located within the hollow center of the graphite rod; and
a spacer that is stable at high temperature and does not react to the graphite rod, wherein the spacer positions the graphite rod at a desired position within the quartz tube,
wherein the quartz tube is sealed with the graphite rod, salt, and spacer therein, and
wherein the tube material does not change its state at a melting temperatures of the salt, the tube material does not release a contaminant when heated to the melting temperature of the salt, and the tube material does not block X-ray beams.

13. The system of claim 12, wherein the spacer is filling material that is not reactive to the tube or to the graphite rod, and which does not melt with increased temperature that causes the salt to become molten salt, and wherein the filling material is positioned beneath the graphite rod between the second end of the quartz tube and the bottom of the graphite rod.

14. The system of claim 13, wherein the filling material is quartz wool.

15. The system of claim 12, wherein the graphite rod further contains a through-hole that extends from a first side of the graphite rod to a second side of the graphite rod, wherein the salt can be accessed through the through-hole.

16. The system of claim 12, further comprising a plug positioned above the open top portion of the rod, closing the opening of the graphite rod, wherein the plug fits within the tube.

17. The system of claim 16, wherein the plug fits entirely within the tube and wherein the system also contains a quartz wool positioned on top of the plug, and wherein the quartz wool also is positioned entirely within the quartz tube.

18. The system of claim 16, wherein the plug is a graphite plug.

19. The system of claim 16, further comprising a second spacer located between the first end of the tube and the plug.

20. The system of claim 12, wherein the tube is sealed.
